(19) United States
(12) Patent Application Publication
(10) Pub. No.: US 2007/0022156 A1
(43) Pub. Date: Jan. 25, 2007

(54) DIGITAL MUSIC SYSTEM

(76) Inventor: Gregory J. Grubbs, Conifer, CO (US)

Correspondence Address: STARKWEATHER & ASSOCIATES, 9035 SOUTH 1300 EAST, SUITE 200, SANDY, UT, 84094, US

(21) Appl. No.: 11/424,151

(22) Filed: Jun. 14, 2006

Related U.S. Application Data
(60) Provisional application No. 60/700,576, filed on Jul. 19, 2005.

(51) Int. Cl. G06F 15/16

(52) U.S. Cl. 709/203

(57) ABSTRACT

A digital music system and method. There is a server and a player in wireless data communication over a local network according to a publicly available data format and a publicly available communication protocol. The server and/or player include: an accessory module, a self-configuration module; a control module, a database module, a network module, a streaming server module, a stream source module, a data translation module, a zone control module, and a stream pulling module. The server module receives a first array of media meta-data; contrasts the first array with a second array corresponding to accessible music; and orders access to an inaccessible media file from a media vendor.

### CROSS-REFERENCE TO RELATED APPLCIATIONS

This invention claims priority, under 35 U.S.C. § 120, to the U.S. Provisional Patent Application No. 60/700,576 to Gregory Grubbs filed on 19 Jul. 2005, which application is incorporated by reference herein.

### BACKGROUND OF THE INVENTION

1. Field of the Invention

The present invention relates to entertainment systems, specifically to digital music systems.

2. Description of the Related Art

Music has long been a social tool for promoting connectivity throughout a culture, promoting free expression, communicating ideas and ideals, and appreciating what is beautiful in life. Accordingly, people throughout history have attempted to make music a greater and greater part of their lives through various means.

For example, Joseph Haydn, the “Father of Symphony” spent a good deal of his life as the music director for the Esterhazy family, at the time one of the most wealthy and influential families in Austria. There Haydn was responsible for the daily performance of an orchestra for the family and their guests. Further, he was provided with sufficient funds to afford the best musicians available for hire. Performances were conducted daily and new compositions were created as quickly as possible in order to provide a continual stream of the best and newest music possible at the time. These great expenditures provided the family with an ability to daily express their appreciation for beauty to their guests as well as providing them an ability to appreciate music at a level and consistency likely never before experienced by anyone.

In a more contemporary example, it is common for individuals having personal web pages, such as those at w/w www.myspace.com, to have their favorite music posted or playing on their page as an expression of how they may be feeling, what they are like, what things they like, or to attract similarly interested friends. Even merely listing the names of one or more favorite groups may accomplish one or more of those purposes.

More, music is widely available in a great variety of formats, including radio, cable television, satellite radio, internet radio stations, pod-casts, CD players, etc. These advances have enabled people to make music a greater part of their lives and have further entrenched music in our social structures.

Accordingly, people are motivated to use music as a social tool and have therefore developed better and better ways to experience music and to use music to interact with each other. The following patents, which are hereby incorporated by reference herein, are examples of systems and methods devised to further utilize music:

U.S. Pat. No. 6,757,517 to Chang, details a novel application of wireless networking and digital music technologies to achieve coordinated and synchronized music playback among peer listeners connected by wireless ad-hoc networks. Two or more listeners in local proximity allowed by short-range wireless transmission may participate and listen to the same song at the same time. Moreover, listeners in the transmission range are allowed to discover each other through profile matching. A high matching score may indicate similar preference or taste to a certain music style thereby easily locating mutual interests, which would not have been possible.

U.S. Pat. No. 6,560,651 to Katz et. al, describes a computer network based digital information library system employing authentication and encryption protocols for the secure transfer of digital information library programs to a client computer system and a mobile digital information playback device removably connectable to the client computer system. There may be a computer network based library and information delivery system for accessing and obtaining selected digital information files. The library and information delivery system comprises: 1) a library server having a plurality of digital information files; 2) a client computer system coupled to the library server over a network; and 3) a mobile device removably connectable to the client computer system, the client computer system including logic for requesting a download of a selected one or more of the digital information files from the library server, the client computer system further including logic for downloading the selected one or more of the digital information files to the mobile device.

U.S. Pat. No. 6,548,747 to Shibata et al. describes a telephony terminal apparatus that includes a storage section that stores an application program to be executed by a processing section for sending to the server apparatus a search query effective to specify target music performance data and acquiring the target music performance data from the server apparatus for exclusive use by the application program. In the server apparatus, a first distributing section responds to the search query in the form of contents that are dedicated for use by the application program. A second distributing section of the server apparatus responds to a request from the telephony terminal apparatus for distributing second contents of the same target music performance data to the telephony terminal apparatus such that the second contents may be treated by the telephony terminal apparatus independently of the application program.

Problems with current systems include but are not limited to: large amounts of wiring required, great expenses, low quality sound, inelegant configuration, complicated configurations, numerous components, large amplifiers, components that create significant heat, not easily portable, do not conform to standards, inability to control locally and/or centrally, inability to import music from other formats such as CDs, inability to control, too invasive, cost prohibitive, difficult installation, inability to have audio in multiple areas of the home, inability to reconfigure the system, inability to easily reconfigure the system, inability to move speakers, uses too much electricity, inability to travel with the system, and inability to broadcast. Further, the current systems/methods fail to enable individuals to connect, to broadcast their personality to the world, to share in the appreciation of good things, to collaborate, and/or to speak out as an individual.

Accordingly, there exists a need for a digital music system, method, device, apparatus, and/or article of manufacture that solves one or more of the problems herein described or that may come to the attention of one skilled in the art after becoming familiar with this specification.

### SUMMARY OF THE INVENTION

The present invention has been developed in response to the present state of the art, and in particular, in response to the problems and needs in the art that have not yet been fully solved by currently available digital music systems. Accordingly, the present invention has been developed to provide a digital music system, method, device, and/or apparatus.

In one embodiment of the invention, there is a digital music system for enabling open and modular configuration. The system includes one or more of the following: a server module configured to store media meta-data and direct media performance; a player module configured to perform media according to instruction from the control module; and/or wherein the server module and player module are in wireless data communication over a local network according to a publicly available data format and a publicly available communication protocol.

The system may also include an accessory module configured to perform media; and/or a self configuration module configured to authenticate the accessory module and enable control of the accessory module by the server module.

The server module may include: a server control module configured to direct media performance; a database module in communication with the server control module and configured to store meta-data regarding a media file; a network module in communication with the server control module and configured to deliver data over the local network; a streaming server module in communication with the server control module and configured to provide a plurality of data streams; a stream source module in communication with the server control module and configured to enable a plurality of player modules to receive diverse streams; a licensing module in communication with the server control module and configured to restrict the playing of unlicensed media; and/or a data translation module in communication with the network module and configured to convert meta-data to be delivered outside the server module into a publicly available data format.

The player module may include: a zone control module configured to direct media performance; a network module in communication with the zone control module and configured to deliver data over the local network; a data translation module in communication with the network module and configured to convert meta-data to be delivered outside the player module into a publicly available data format; a licensing module in communication with the server control module and configured to restrict the playing of unlicensed media; and/or a stream pulling module configured to receive a stream and deliver stream data to the audio module.

The self configuration module may include: an authentication module configured to receive and validate a certificate; and/or a decryption module configured to decrypt an encrypted certificate from the player module.

There may also be a data translation module in communication with the network module and configured to convert meta-data to be delivered outside the server module into a publicly available data format.

The server module may include a meta-data propagation module in communication with the database module and configured to deliver an array of meta-data outside of the local network according to a publicly available protocol and data format.

The server module may be in data communication with the internet and may propagate media meta-data thereto. The server module may performs the steps of: receiving a first array of media meta-data according to a publicly available format and protocol; contrasting the first array with a second array of media meta-data, the second array corresponding to a list of music files accessible by the server module; determining that an inaccessible media file described in the first array is not accessible; and/or ordering access to the inaccessible media file from a media vendor by delivering to the media vendor an array of meta-data corresponding to the inaccessible media file according to a publicly available format and protocol.

In another embodiment of the invention, there is a method for producing a digital open modular music system. The method includes: providing a server module in communication with a local network according to a publicly available format and protocol; and/or providing a player module in communication with the server module according to a publicly available format and protocol and configured to play media. There may also be the steps of: providing an accessory module configured to perform media; providing a self configuration module configured to authenticate the accessory module and enable control of the accessory module by the server module; providing a server control module configured to direct media performance; providing a database module in communication with the server control module and configured to store meta-data regarding a media file; providing a network module in communication with the server control module and configured to deliver data over the local network; providing a streaming server module in communication with the server control module and configured to provide a plurality of data streams; providing a stream source module in communication with the server control module and configured to enable a plurality of player modules to receive diverse streams; and/or providing a data translation module in communication with the network module and configured to convert meta-data to be delivered outside the server module into a publicly available data format.

The method may also include: providing a zone control module configured to direct media performance; providing a network module in communication with the zone control module and configured to deliver data over the local network; providing a data translation module in communication with the network module and configured to convert meta-data to be delivered outside the player module into a publicly available data format; providing a stream pulling module configured to receive a stream and deliver stream data to the audio module; providing an authentication module configured to receive and validate a certificate; providing a decryption module configured to decrypt an encrypted certificate from the player module; providing a data translation module in communication with the network module and configured to convert meta-data to be delivered outside the server module into a publicly available data format; receiving a first array of media meta-data according to a publicly available format and protocol; contrasting the first array with a second array of media meta-data, the second array corresponding to a list of music files accessible by the server module; determining that an inaccessible media file described in the first array is not accessible; and/or ordering access to the inaccessible media file from a media vendor by delivering to the media vendor an array of meta-data corresponding to the inaccessible media file according to a publicly available format and protocol.

In a still further embodiment, there may be an article of manufacture. The article of manufacture may include a computer usable medium having computer readable program code embodied therein, the computer readable program code providing instruction for carrying out the steps of: providing a server module in communication with a local network according to a publicly available format and protocol; providing self-configuration, communication, and integration of a player module according to a publicly available format and protocol; receiving a first array of media meta-data according to a publicly available format and protocol; contrasting the first array with a second array of media meta-data, the second array corresponding to a list of music files accessible by the server module; determining that an inaccessible media file described in the first array is not accessible; and/or ordering access to the inaccessible media file from a media vendor by delivering to the media vendor an array of meta-data corresponding to the inaccessible media file according to a publicly available format and protocol.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order for the advantages of the invention to be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 illustrates an exemplary block diagram of a system according to one embodiment of the invention;

FIG. 2 illustrates a module diagram of a system according to one embodiment of the invention;

FIG. 3 illustrates a module interaction diagram according to one embodiment of the invention;

FIG. 4 illustrates a module diagram of a zone player according to one embodiment of the invention; and

FIG. 5 illustrated a sequence diagram showing an embodiment of the invention in operation.

### DETAILED DESCRIPTION OF THE INVENTION

For the purposes of promoting an understanding of the principles of the invention, reference will now be made to the exemplary embodiments illustrated in the drawings, and specific language will be used to describe the same. It will nevertheless be understood that no limitation of the scope of the invention is thereby intended. Any alterations and further modifications of the inventive features illustrated herein, and any additional applications of the principles of the invention as illustrated herein, which would occur to one skilled in the relevant art and having possession of this disclosure, are to be considered within the scope of the invention.

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

As used herein, “meta-data” refers to information about a set of data. For example, wherein a particular set of music information may be a music file, like an mp3 of a song, music information meta-data may be the title of the song, the artist, the album from which the song comes, the duration of the song, a particular mood to which the song belongs, etc.

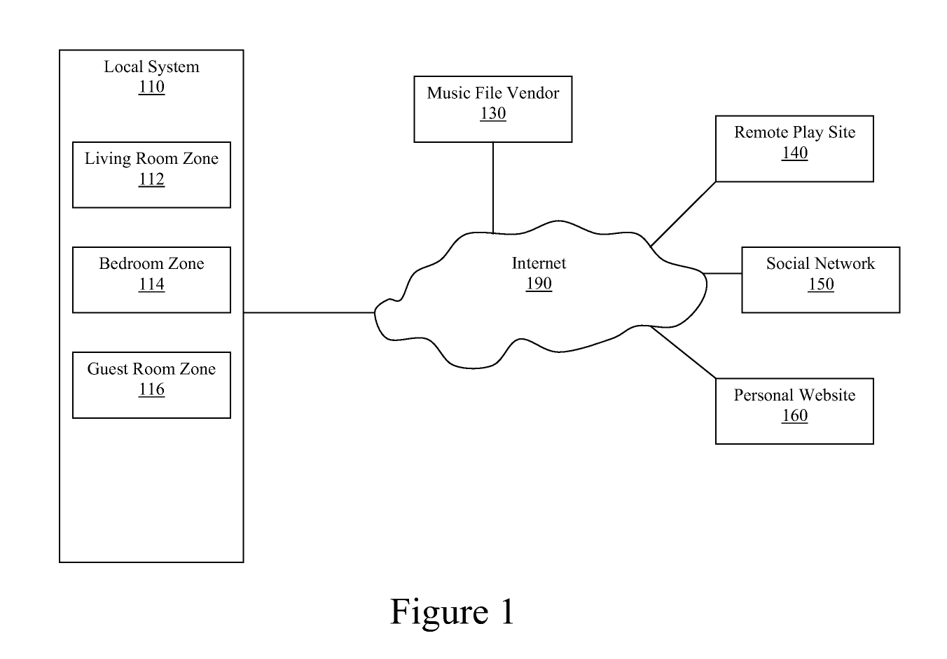

Looking to FIG. 1, there is shown a local system 110 in communication with a global network such as the internet 190. In the illustrated embodiment, the local system 110 is connectable to a plurality of remote modules through the internet 190 and may interact with such in a great variety of ways. Further, such remote modules may indirectly interact with each other through the local system 110.

The illustrated local system 110 is an entertainment system at a facility, such as but not limited to a home, a building, a business, a shopping center, etc. The illustrated local system 110 includes a plurality of zones, namely a living room zone 112, a bedroom zone 114, and a guest room zone 116, attributable to a home system. Each of these zones represents at least a single zone player that may provide media content independently of the others. Accordingly, while a particular play-list is playing in the living room zone 112, a different play-list may be playing in the bedroom zone 114.

As described, the following modules are in communication with the internet 190: a music file vendor 130; a remote play site 140; a social network 150; and a personal website 160. It is contemplated that the variety of modules that could be connected are plethoric and the above mentioned modules are non-limiting examples.

Non-limiting examples of music file vendors 130 include: Rhapsody®at www.Rhapsody.com; Emusic®at www.emusic.com; MP3.com®at www.mp3.com; and Apple iTunes® at www.itunes.com. Music file vendors 130 include those entities offering music data for sale, rent, lease, or otherwise providing access to music data for compensation. The music file vendors 130 may receive requests for music data according to standard protocols and data formats and then may provide such music data to the local system.

A remote play site 140 is similar to a zone of the local system 110 except that the remote play site 140 is remote from the local system 110. In one non-limiting example, the illustrated local system 110 covers a home and the illustrated remote play site 140 is a zone player in a separate local system in a summer home.

A social network 150 includes a group of people in communication over the internet. Non-limiting examples include blogs, message boards, internet communities, etc. In one non-limiting example, there may be a collection of social networks organized according to music preferences.

A personal website 160 includes a website focusing on a particular person or entity. Examples include family websites, company websites, websites focusing on the interests of a particular person. One example of a collection of personal websites is

In operation the illustrated embodiment of the invention enables functional connectivity between the illustrated modules. Such connectivity may be limited to music meta-data, information describing music but not the music information itself. For example, the connectivity may include sending descriptions of play-lists, but not including the actual music files of the individual songs on the play-list. Accordingly, one may be able to populate a field on a personal web page 160 with a name of a song currently playing in the bedroom zone 114 in order to satisfy expressive needs, but a viewer of the web page may not be able to listen to the song unless the viewer also owns a copy of the song. Further non-limiting examples of use will be provided after a discussion of modules present in one embodiment of the local system.

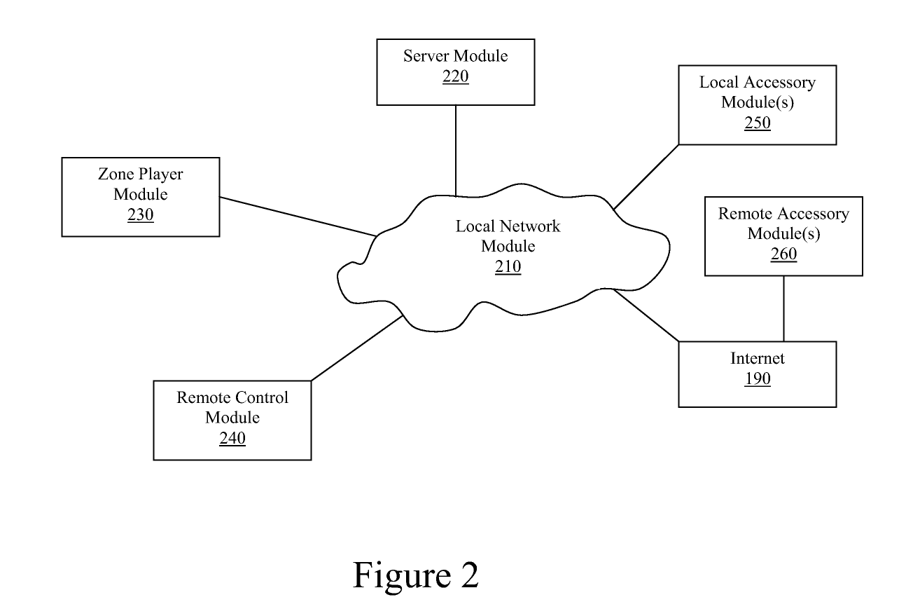

FIG. 2 illustrates a module diagram of a system according to one embodiment of the invention. This view provides more detail to the local system 110 of FIG. 1. There is shown a local network module 210 in communication with each of: a server module 220, a zone player module 230, a remote control module 240, the internet 190, and a local accessory module 250. Through the internet 190 (or another large network, such as a global network) the local network module is in communication with a remote accessory module 260. The local network module 210 may be a LAN or other similar communication network configured to provide communicative connectivity to modules in a local area, such as but not limited to a home, building, business, facility, campus, etc.

The illustrated server module 220 includes a server as is commonly known in the art for server-client systems. In one non-limiting example, there is an Intel-compatible CPU, like the VIA “Nehemiah” M-10000, 1 GHz clock speed; an AC97-compatible sound card, like the VIA Technologies, Inc. VT8233/A/8235/8237 AC97 Audio Controller; an Ethernet networking card, as provided by the VIA Technologies, Inc. VT6102 [Rhine-II]. There may also be a GS-L03 case by Genius Power Technology Inc. of Shenzhen China, purchasable at www.bwi.com; a J627FWE1GC motherboard by Jetway computer of Newark Calif. (1 GHz VIA C3 CPU, Via VT8623 chipset); 512 MB RAM memory; 40 GB or larger hard drive; a CD drive; and/or on-board Ethernet.

The illustrated zone player module 230 may include a client system as is commonly known in the art for client server systems. In one non-limiting example, there is an Intel-compatible CPU, like the VIA “Eden” processor, 500 MHz clock speed AC97-compatible sound card; Ethernet networking, as provided by Realtek Semiconductor Co., Ltd. RTL-8139/8139C/8139C+; and/or 802.11b/g wireless networking, like the Ralink 802.11g WLAN USB adapter (RT2570).

The mini-ITX form factor used by VIA Technologies is a possible choice for the main unit and/or the room players. There are many manufacturers of cases for these boards, including Morex and Casetronic. The zone player module may be assembled using: a Cubid 2688 case by Morex of Fremont Calif.; an IP-4GMS6F motherboard by Epox of Shanghai China (600 MHz Intel Celeron CPU); 64 MB RAM memory; 65 MB CompactFlash storage; and/or on-board Ethernet.

The illustrated remote control module 240 may includes a handheld device in communication with the local network module 210. In one non-limiting example, the remote control module is a PDA (“Personal Digital Assistant”) such as but not limited to a Sharp Zaurus SL-6000 802.11b/g enabled wireless, running a web browser. Accordingly, a user may enter information therein to be transmitted to the server module 220 and may receive information therefrom.

The illustrated local accessory module 250 includes accessory modules present in the local environment and in communication with the local network module 210. Non-limiting examples of such include: specialized speakers, personal media devices like iPods (by Apple Computers of Cupertino, Calif.), music visualization devices, etc. It is understood that the variety of local accessory modules is plethoric.

The illustrated remote accessory module 260 includes accessory modules including foreign server modules and zone player modules that are exterior the local environment.

In one embodiment, the server module performs the steps of: receiving a first array of media meta-data according to a publicly available format and protocol; contrasting the first array with a second array of media meta-data, the second array corresponding to a list of music files accessible by the server module; determining that an inaccessible media file described in the first array is not accessible; and ordering access to the inaccessible media file from a media vendor by delivering to the media vendor an array of meta-data corresponding to the inaccessible media file according to a publicly available format and protocol. Accordingly, where a user may desire to play a playlist of another that may have been delivered to the user, the user may configure the system to automatically purchase access to inaccessible music files on the playlist.

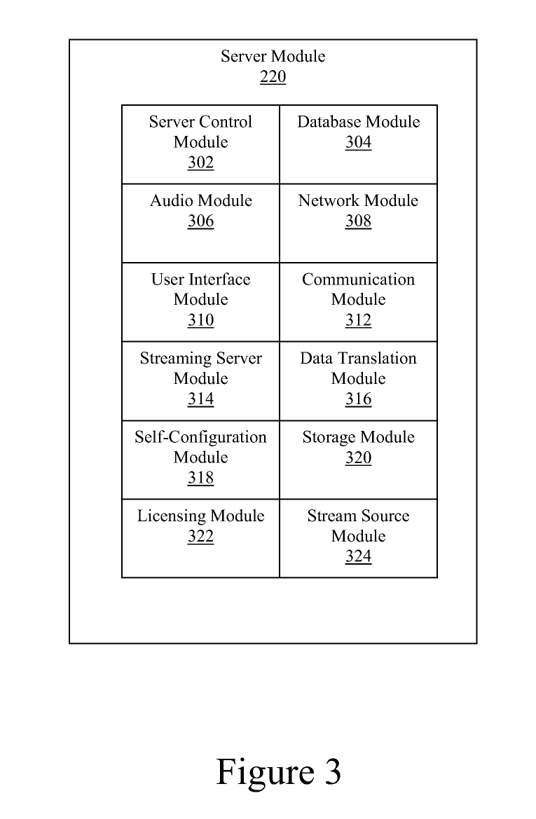

FIG. 3 illustrates a module interaction diagram according to one embodiment of the invention. The server module 220 includes a plurality of modules for carrying out the functions associated with the server module. The plurality of modules are generally embodied as software modules, but may be embodied otherwise. There is shown a server module 220 including: a server control module 302; a database module 304; an audio module 306; a network module 308; a user interface module 310; a communication module 312; a streaming server module 314; a data translation module 316; a self-configuration module 318; a storage module 320; a licensing module 322; and a stream source module 324.

The server control module 302 determines and gives instructions to other modules such as but not limited to the zone player module, the audio module, and/or the stream source module. The server control module may include a CPU and/or instructions for receiving information and creating instructions to be sent.

The database module 304 stores, organizes, and/or includes meta-data relating to music information. In one embodiment, MySQL by MySQL AB of Uppsala Sweden is included in the database module 304.

The audio module 306 includes a media player such as but not limited to MADPLAYER or MPLAYER by available at www.mplayerhq.hu.

The network module 308 includes instructions for communication over a network according to an established protocol. In one embodiment, the network module 308 may include network drivers, such as but not limited to Ethernet providing instructions for a TCP/IP network. There may be a network card such as but not limited to NIC cards by 3COM of Marlborough Mass.

The user interface module 310 includes instructions for controlling interactions with a user and may be written in php with some shell script and C programs.

The communication module 312 includes accesses the user interface module 310 and delivers the interface. In one embodiment, a communication module includes Apache web-server software by The Apache Software Foundation of Forest Hill Md. In one embodiment the communication module 312 displays a website configured receive control commands from a user and/or to display a GUI.

The streaming server module 314 includes instructions for delivering one or more stream sources over the network. In one embodiment, the streaming server module 314 includes Ice Cast by the Xiph Open Source Community at www.icecast.org.

The data translation module 316 includes instructions for converting data, such as but not limited to metadata, to a standard data format such as but not limited to REST or XML. In one embodiment, the data translation module converts control statements. In one embodiment, the data translation module does not convert execution statements. Wherein a system may include portions that communicate according to a same or substantially similar format, a data translation module may be skipped for communication between such. Accordingly, a data translation module may be most useful when communicating with third party devices, systems, and/or network services.

In one embodiment, a data translation module stores schemas for various formats like XML formats likely to be needed. Such may be drawn from a collection of publicly available formats. A data translation module may allow services to be published and queried automatically. In one embodiment, a data translation module may be a web services-type module such as web services modules in use in enterprise software. Examples include web services API such as but not limited to SOAP by W3C of Caimbridge Mass. (http://www.w3.org/TR/soap/) and XML-RPC of UserLand Software of Danville Calif. (www.xmlrpc.com).

In one embodiment, a data translation module may be different from the above listed examples in that wherein there is a very specific purpose for the existence of the module, which is to operate in a music playing environment, it can translate non-xml statements. Accordingly, there may be a tool that operates on one or more assumptions that statements may relate only with media playing. Therefore, there may be a limited universe of commands, like play and connect. Further, it may be that all the internal commands are all well defined, limited command set. Accordingly, such a tool, as part of a data translation module, may be capable of taking non-xml formats and translating them into the system. One may receive these other formats and then use a schema to either generate or to parse and then parse the data directly into an internal data structure. If one has a need to serialize (such as with REST), there may be a serializing module for serializing into REST format or into script commands.

The self-configuration module 318 includes instructions for authentication of other modules such as but not limited to zone player modules and/or accessory modules. The self-configuration module 318 may send and/or receive certificates via ssh that may be encrypted.

In one embodiment, a self-configuration module 318 may integrate new zone players into a system. A user may simply buy one or more new zone players and turn them on and tell the server module to find them and set them up. The zone players may include a certificate serving module (such as but not limited to by using ssh). The server may also include functionality of a zone player and accordingly may include a certificate serving module.

In one embodiment, a process for self/auto configuration includes: user commands search for zone players; the server control module initiates a network scan looking for things that have both a communication module and a certificate module; when it finds them it queries configuration information (such as but not limited to: if the module is a zone player or not, what port the communication module is on, if information is at root or subdirectory; and/or anything else that the server module needs to know to use the zone player). In one embodiment, everything else is standardized for zone players.

Additional information may be needed for different kinds of zone players and or accessories such as third party modules. Later, through manual data entry or otherwise, a zone player may be named whatever the user wants (Guest Bedroom, Kitchen, Laundry Room, etc.). In one embodiment, a self-configuration module is similar in functionality to plug-and-play, but instead over a network. In one embodiment, a self-configuration module is similar to printing services over a network, such as but not limited to IPP (internet printing protocol) with self-configuring printers, such as those offered by Hewlett Packard of Palo Alto Calif.

The storage module 320 stores data, such as but not limited to music information (music files such as mp3 or wav files). The storage module may include one or more storage devices, such as but not limited to a hard drive, and may include an OS system such as a Windows or DOS OS by Microsoft Corporation of Redmond, Wash.

The licensing module 322 includes instructions for the prevention of copying and/or playing unlicensed music information and/or the instructions for obtaining such licenses. Non-limiting examples of such include copy protection systems and digital rights management systems included in Microsoft® Media Player and Apple® iTunes.

The stream source module 324 includes instructions for processing a list of files to play and/or relaying a stream. A stream source module 324 may feed a list of files to play to the streaming server module 314, which streams zero or more feeds at a time. The stream source module 324 may be in communication with one or more other modules and may ask for a stream to relay to the streaming server module 314. Generally, there may be one stream source module instance per playlist. A stream source module 324 may define a stream. There may be multiple streams feeding one or more zone player modules. In one embodiment, a stream source module manages a playlist from a file system, and it may also be pulling music from an outside source such as internet radio. In one non-limiting example, the stream source module 324 includes Ices which may be found at www.icecast.org.

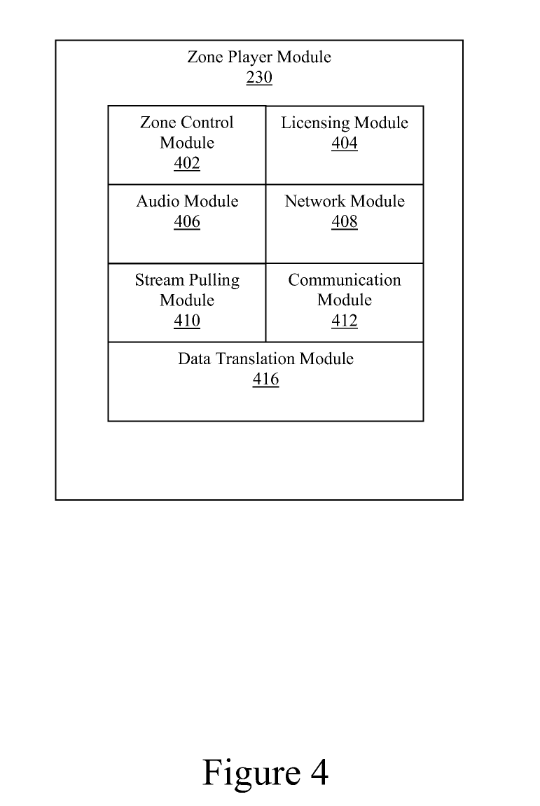

FIG. 4 illustrates a module diagram of a zone player according to one embodiment of the invention. There is shown a zone player module 230 including: a zone control module 402, a licensing module 404, an audio module 406, a network module 408, a stream pulling module 410, a communication module 412, and a data translation module 416. The licensing module 404, audio module 406, network module 408, communication module 412, and data translation module 416 may be substantially similar to, or included with the associated modules of the server module 220.

The zone control module 402 determines and gives instructions to other modules such as but not limited to the audio module 406, and/or the stream pulling module 410.

The stream pulling module 410 includes instructions for (generally zero or one instance per zone player) connecting to the streaming server module 314 and asking for one of the streams. A stream pulling module 410 may include wget (see www.wget.sunsite.dk) and/or curl UNIX commands. Winamp by Nullsoft (www.nullsoft.com) is an example of a media player having a stream pulling module as Winamp may be ordered to play a URL.

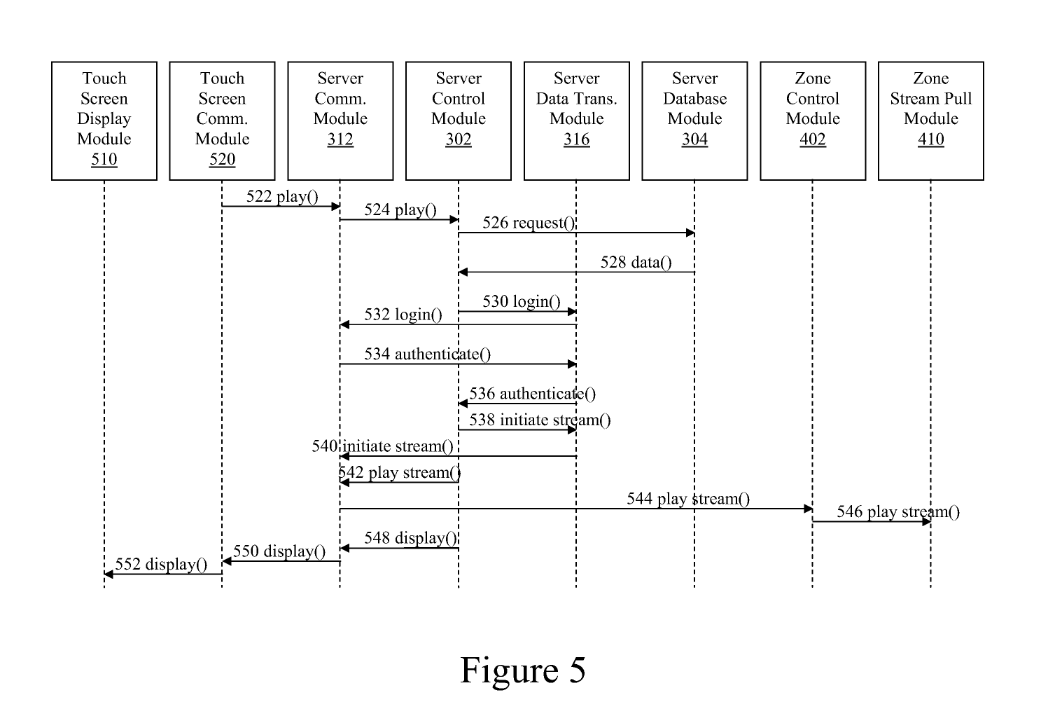

FIG. 5 illustrates a sequence diagram showing an embodiment of the invention in operation. In particular, a user initiates a play command on a touch screen (corresponding to the remote control module 240 of FIG. 1). For example, the command may be to play a playlist named “Americana Radio” in the zone “Den.” In the illustrated example, the various network modules are not illustrated but action by such are implied where appropriate.

The touch screen software generates a play command in REST format and the touch screen communication module 520 then sends 522 the play command to the server where it is received by the server communication module 312. The server communication module 312 transmits 524 the play command to the server control module 302 where the command is interpreted. The server control module 302 generates and sends 526 a request to the server database module 304 for radio station metadata for the playlist “Americana” and for login metadata for the same. The request 526 may include more than one request.

In reply, the server database module 304 returns 528 the data requested. The return 528 may include more than one transmission of data. The server control module 302 then sends 530 a login request including login data. The login request 530 is received by the data translation module 316 and is there translated to XML format and relayed 532 to the server communication module 312 where it is then further relayed until received by the appropriate login module, such as an internet radio host.

When authentication is received by the server communication module 312 it is relayed 534 to the server data translation module 316 where it is translated to the internal data structure and then delivered 536 to the server control module 302. The server control module 302 receives the authentication and then generates a command to initiate stream which is relayed 538 to the data translation module 316 for conversion to the data format of the internet radio station and then relays 540 the converted command to the server communication module 312. From there it is delivered to the internet radio station.

Also, a command to play stream is generated by the server control module 302. Because the zone player module uses the same data format as the server module, no data translation is needed. Accordingly, the command is delivered 542 directly to the server communication module 312 to be relayed 544 to the zone control module 402. There the command is interpreted and a new command to play stream is generated by the zone control module 402 and issued 546 to the zone stream pull module 410 where the command is executed.

More, a command to display a new play status is generated by the server control module 302. Because the touch screen uses the same data format as the server module, no data translation is needed. Accordingly, the command is delivered 548 directly to the server communication module 312 to be relayed 550 to the touch screen communication module 520 where it is relayed 552 to the touch screen display module 510 for execution of a display update.

In another embodiment, a command to display a new play status is generated by the server control module 302. The command may be delivered to the data translation module 316 to be translated, such as to JSON format. The translated command may then be delivered to the touch screen communication module 520 through the server communication module 312. Then the command may be relayed to the touch screen display module 510 where Javascript may be called to natively parse the command for execution of a display update.

Accordingly, the user need merely select a mood, playlist, station, song, source, etc. together with a zone player, and the music begins to play regardless of whether the music source is part of the internal system or not. Advantageously, the internal system may interact with other systems seamlessly for the benefit of the user.

In order to demonstrate the practice of the present invention, the following examples have been prepared. The examples should not, however, be viewed as limiting the scope of the invention. The claims will serve to define the invention. Further, in the examples, for simplification, network module(s) are not mentioned, but act when necessary to communicate over networks, such as between pairs of communication modules.

In one embodiment, a user may be enabled to publish music meta-data to a website, such as a personal website. The embodiment may translate music meta-data to an RSS feed and deliver that feed to the website. The user may publicly display a favorite playlist, a currently playing song, a favorite artist, etc.

In one embodiment, a user may be enabled to connect to a music publisher, such as through a website, for a music stream. Examples include Rhapsody Music and Yahoo! Music.

In one embodiment, a user may use the touch screen interface to select a mood to play in a room. A mood may be a collection of media files associated according to a characteristic.

The user may, using the touch screen, tap on mood “Romance” and room “Den.” The touch screen display software may generate a command in REST format and the touch screen communication module may deliver that command to the server communication module. The server communication module relays that command to the server control module (perhaps via the server data translation module if translation is needed) where the command is interpreted. The server control module may call the database module, the streaming server module, the stream source module, and/or the storage module to queue the mood and start the stream. As these may be commands internal to the server module, generally no data translation is necessary. Further, the server control module may generate a command to play the stream. The command to play the stream is delivered to the zone player labeled “Den” via the server communication module (being first translated at the data translation module if necessary) and the zone player communication module. There the “Den” zone player control module interprets the command and calls the zone player stream pulling module which executes the command to pull the stream playing the “Romance” mood.

In another embodiment, a user using the touch screen requests a song/stream update for a particular zone. The display software of the touch screen generates a command in REST format to request an update and delivers it to the server control module via the touch screen communication module and the server communication module (being translated if necessary). The server control module interprets the command and generates a command to query the stream data for the particular zone. The query command is delivered to the stream source module which returns the requested information. The server control module receives the information and generates a statement which is translated to JSON format by the data translation module for delivery to the touch screen via the associated communication modules. The display software invokes JavaScript to natively parse the translated (JSON) statement and display the results of the request.

In another embodiment, a user uses a touch screen to instruct a room player to increase volume. The display software generates a command in REST which is delivered by the touch screen communication module to the zone control module either through the server module or directly to the zone player communication module. The zone control module interprets the command and calls the audio module to increment the volume to the new level. Data regarding the change is translated to JSON through the zone player data translation module and then delivered back to the touch screen for parsing as described above.

Advantageously, an embodiment of the invention enables a user great freedom and power and may be used in a near infinite set of modes. Accordingly, the user is free to explore, share ideas and feelings, collaborate, and/or customize as desired. The user is free and enabled to carve their own path, find and build their own communities, make deeper connections and/or innovate.

It is understood that the above-described preferred embodiments are only illustrative of the application of the principles of the present invention. The present invention may be embodied in other specific forms without departing from its spirit or essential characteristics. The described embodiment is to be considered in all respects only as illustrative and not restrictive. The scope of the invention is, therefore, indicated by the appended claim rather than by the foregoing description. All changes which come within the meaning and range of equivalency of the claims are to be embraced within their scope.

Thus, while the present invention has been fully described above with particularity and detail in connection with what is presently deemed to be the most practical and preferred embodiment of the invention, it will be apparent to those of ordinary skill in the art that numerous modifications, including, but not limited to, variations in size, materials, shape, form, function and manner of operation, assembly and use may be made, without departing from the principles and concepts of the invention as set forth in the claims

What is claimed is:

1. A digital music system for enabling open and modular configuration, comprising:
a) a server module configured to store media meta-data and direct media performance;
b) a player module configured to perform media according to instruction from the control module; and
c) wherein the server module and player module are in wireless data communication over a local network according to a publicly available data format and a publicly available communication protocol.

2. The system of claim 1, further comprising:
a) an accessory module configured to perform media; and
b) a self configuration module configured to authenticate the accessory module and enable control of the accessory module by the server module.

3. The system of claim 2, wherein the server module comprises:
a) a server control module configured to direct media performance;
b) a database module in communication with the server control module and configured to store meta-data regarding a media file;
c) a network module in communication with the server control module and configured to deliver data over the local network;
d) a streaming server module in communication with the server control module and configured to provide a plurality of data streams;
e) a stream source module in communication with the server control module and configured to enable a plurality of player modules to receive diverse streams; and
f) a data translation module in communication with the network module and configured to convert meta-data to be delivered outside the server module into a publicly available data format.

4. The system of claim 2, wherein the player module comprises:
a) a zone control module configured to direct media performance;
b) a network module in communication with the zone control module and configured to deliver data over the local network;
c) a data translation module in communication with the network module and configured to convert meta-data to be delivered outside the player module into a publicly available data format; and
d) a stream pulling module configured to receive a stream and deliver stream data to the audio module.

5. The system of claim 2, wherein the self configuration module further comprises:
an authentication module configured to receive and validate a certificate; and
a decryption module configured to decrypt an encrypted certificate from the player module.

6. The system of claim 1, further comprising a data translation module in communication with the network module and configured to convert meta-data to be delivered outside the server module into a publicly available data format.

7. The system of claim 6, wherein the data translation module is in communication with the database module and is configured to deliver an array of meta-data outside of the local network according to a publicly available protocol and data format.

8. The system of claim 2, wherein the server module is in data communication with the internet and may propagate media meta-data thereto.

9. The system of claim 8, wherein the server module performs the steps of:
a) receiving a first array of media meta-data according to a publicly available format and protocol;
b) contrasting the first array with a second array of media meta-data, the second array corresponding to a list of music files accessible by the server module;
c) determining that an inaccessible media file described in the first array is not accessible; and
d) ordering access to the inaccessible media file from a media vendor by delivering to the media vendor an array of meta-data corresponding to the inaccessible media file according to a publicly available format and protocol.

10. The system of claim 3, wherein the server module further comprises a licensing module in communication with the server control module and configured to restrict the playing of unlicensed media.

11. The system of claim 4, wherein the player module further comprises a licensing module in communication with the server control module and configured to restrict the playing of unlicensed media.

12. A method for producing a digital open modular music system, comprising:
a) providing a server module in communication with a local network according to a publicly available format and protocol; and
b) providing a player module in communication with the server module according to a publicly available format and protocol and configured to play media.

13. The method of claim 12, further comprising:
a) providing an accessory module configured to perform media; and
b) providing a self configuration module configured to authenticate the accessory module and enable control of the accessory module by the server module.

14. The method of claim 13, further comprising:
a) providing a server control module configured to direct media performance;
b) providing a database module in communication with the server control module and configured to store meta-data regarding a media file;
c) providing a network module in communication with the server control module and configured to deliver data over the local network;
d) providing a streaming server module in communication with the server control module and configured to provide a plurality of data streams;
e) providing a stream source module in communication with the server control module and configured to enable a plurality of player modules to receive diverse streams; and
f) providing a data translation module in communication with the network module and configured to convert meta-data to be delivered outside the server module into a publicly available data format.

15. The method of claim 13, further comprising:
a) providing a zone control module configured to direct media performance;
b) providing a network module in communication with the zone control module and configured to deliver data over the local network;
c) providing a data translation module in communication with the network module and configured to convert meta-data to be delivered outside the player module into a publicly available data format; and
d) providing a stream pulling module configured to receive a stream and deliver stream data to the audio module.

16. The method of claim 13, further comprising:
providing an authentication module configured to receive and validate a certificate; and
providing a decryption module configured to decrypt an encrypted certificate from the player module.

17. The method of claim 12, further comprising providing a data translation module in communication with the network module and configured to convert meta-data to be delivered outside the server module into a publicly available data format.

18. The method of claim 12, further comprising:
a) receiving a first array of media meta-data according to a publicly available format and protocol;
b) contrasting the first array with a second array of media meta-data, the second array corresponding to a list of music files accessible by the server module;
c) determining that an inaccessible media file described in the first array is not accessible; and
d) ordering access to the inaccessible media file from a media vendor by delivering to the media vendor an array of meta-data corresponding to the inaccessible media file according to a publicly available format and protocol.

19. An article of manufacture, comprising:
a computer usable medium having computer readable program code embodied therein, the computer readable program code providing instruction for carrying out the steps of:
a) providing a server module in communication with a local network according to a publicly available format and protocol; and
b) providing self-configuration, communication, and integration of a player module according to a publicly available format and protocol.

20. The article of manufacture of claim 19, wherein the computer readable code further provides instructions for carrying out the further steps of:
a) receiving a first array of media meta-data according to a publicly available format and protocol;
b) contrasting the first array with a second array of media meta-data, the second array corresponding to a list of music files accessible by the server module;
c) determining that an inaccessible media file described in the first array is not accessible; and
d) ordering access to the inaccessible media file from a media vendor by delivering to the media vendor an array of meta-data corresponding to the inaccessible media file according to a publicly available format and protocol.
